(19) United States
(12) Patent Application Publication
(10) Pub. No.: US 2017/0364935 A1
(43) Pub. Date: Dec. 21, 2017

(54) METHOD AND SYSTEM FOR AWARD IDENTIFICATION BASED ON TRANSACTIONAL BEHAVIOR AND INTERESTS

(71) Applicant: MasterCard International Incorporated, Purchase, NY (US)

(72) Inventors: Cristina PALSAR, Armonk, NY (US); Natalia UMEOKA, New York, NY (US)

(73) Assignee: MasterCard International Incorporated, Purchase, NY (US)

(21) Appl. No.: 15/183,446

(22) Filed: Jun. 15, 2016

(51) Int. Cl. G06Q 30/02

(52) U.S. Cl. CPC G06Q 30/0212; G06Q 30/0226

(57) ABSTRACT

A method for award identification based on transactional behavior and interests comprising: identifying a subset of transaction data entries stored in the transaction database, wherein each transaction data entry in the subset includes the transaction account; determining, when the subset of transaction data entries exceeds a predetermined threshold; qualifying, the transaction account for an entry into a random drawing; identifying, winning transaction account from the plurality of transaction accounts that were entered into the random drawing; identifying at least one set of interest characteristics for the winning transaction account by: querying the demographic database and the profile database to identify, from an award database, a surprise based on the life stage and specific identified area of special interest of the consumer; and transmitting notice of the identified surprise to a computing device of the consumer.

### FIELD

The present disclosure relates to the method and system for award identification, based on transaction history and behavior, specifically the analysis of transaction data for a merchant and use thereof to determine consumer interests for use in determining meaningful awards to be provided to consumers.

### BACKGROUND

Payment cards, such as credit cards, debit cards, etc. can be a beneficial tool for consumers to use. Because of the utility of payment cards, many consumers may have multiple payment cards, and in some instances may possess payment cards from multiple issuers. As a result, issuers may often try and provide incentives for consumers to use payment cards that they have issued. One such incentive is the use of reward points, cash back, or other type of currency that may be redeemed by the consumer, that may be awarded for eligible purchases made using associated payment cards.

Consumer reward systems, such as reward points, are used by many issuing banks and other financial institutions to provide an incentive for a consumer to use one payment method over another. In many instances, a consumer may use a payment card or other payment instrument to fund a payment transaction, and receive a number of points or other rewards based on the transaction amount and other considerations. The consumer may accumulate these points over time and redeem them for products, cash back, or other benefits.

However, as more and more payment cards begin to offer rewards for their use, such reward programs may no longer be attractive enough to consumers to influence payment card use due to the similarities between programs offered by each payment card. Many consumers aim for more spontaneity in their lives and bonding opportunity. As a result, issuers may be interested in additional methods for incentivizing use of a payment card which creates an emotional connection to the brand. A problem is that there are tens of thousands or more potential customers and potentially tens of thousands or more potential transactions. It is not possible to have humans provide enough meaningful contact to promote loyalty through meaningful interaction. Instead, automated computing systems are required, but can be impersonal. Thus, there is a need for additional systems and methods for determining meaningful and personal awards to be provided to consumers to promote consumer loyalty and provide a more active experience.

### SUMMARY

The present disclosure provides a description of systems and methods for award identification based on transactional behavior and interests.

A method for award identification based on transactional behavior and interests, comprising: storing, in a transaction database of a processing server, a plurality of transaction data entries, wherein each transaction data entry includes data related to a payment transaction including at least a merchant identifier associated with a merchant involved in the related payment transaction, a primary account number associated with a transaction account used in the related payment transaction, and transaction data; storing, in a demographic database of a processing server, a plurality of demographic data entries, wherein each demographic data entry includes data related to a life stage associated with a consumer utilizing the primary account number associated with the transaction account used in the related payment transaction; storing, in an account database of the processing server, a plurality profile data entries, wherein each profile data entry includes data related to a specific identified area of special interest associated with the consumer utilizing the primary account number associated with the transaction account used in the related payment transaction; identifying, by a processing device of the processing server, a subset of transaction data entries stored in the transaction database, wherein each transaction data entry in the subset includes the transaction account; determining, by the processing device of the processing server, when the subset of transaction data entries exceeds a predetermined threshold; qualifying, by the processing device of the processing server, the transaction account for an entry into a random drawing, the random drawing comprising a plurality of transaction accounts which have exceeded the predetermined threshold; identifying, by the processing device of the processing server, a winning transaction account from the plurality of transaction accounts that were entered into the random drawing, wherein the winning transaction account is chosen randomly; identifying, by the processing device of the processing server, at least one set of interest characteristics for the winning transaction account by: querying, by a querying module of the processing server, the demographic database and the profile database to identify, from an award database, a surprise based on the life stage and specific identified area of special interest of the consumer; and transmitting, by a transmitting device of the processing server, notice of the identified surprise to a computing device of the consumer.

A system for award identification based on transactional behavior and interests, comprising: a transaction database of a processing server configured to store a plurality of transaction data entries, wherein each transaction data entry includes data related to a payment transaction including at least a merchant identifier associated with a merchant involved in the related payment transaction, a primary account number associated with a transaction account used in the related payment transaction, and transaction data; a demographic database of a processing server configured to store a plurality of demographic data entries, wherein each demographic data entry includes data related to a life stage associated with a consumer utilizing the primary account number associated with the transaction account used in the related payment transaction; an account database of the processing server configured to store a plurality profile data entries, wherein each profile data entry includes data related to a specific identified area of special interest associated with the consumer utilizing the primary account number associated with the transaction account used in the related payment transaction; a processing device of the processing server configured to: identify a subset of transaction data entries stored in the transaction database, wherein each transaction data entry in the subset includes the transaction account; determine when the subset of transaction data entries exceeds a predetermined threshold; qualify the transaction account for an entry into a random drawing, the random drawing comprising a plurality of transaction accounts which have exceeded the predetermined threshold; identify a winning transaction account from the plurality of transaction accounts that were entered into the random drawing, wherein the winning transaction account is chosen randomly; and identify at least one set of interest characteristics for the winning transaction account by querying the demographic database and the profile database to identify, from an award database, a surprise based on the life stage and specific identified area of special interest of the consumer; and a transmitting device configured to transmit notice of the identified surprise to a computing device of the consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the award identification based on transactional behavior and interests in accordance with exemplary embodiments.

FIG. 2 is a block diagram illustrating the processing server of FIG. 1 for the award identification based on transactional behavior and interests in accordance with exemplary embodiments.

FIG. 3 is a flow diagram illustrating a process for award identification based on transactional behavior and interests using the system of FIG. 1 in accordance with exemplary embodiments.

FIG. 4 is a flow diagram illustrating a method for award identification based on transactional behavior and interests using the processing server of FIG. 2 in accordance with exemplary embodiments.

FIG. 5 is a flow chart illustrating an exemplary method for award identification based on transactional behavior and interests in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Data Provider—The data provider may be an entity which is configured to collect social network data from the social network. The social network data may include data related to content shared by users of the social network, as well as information associated with individual users and their followers. In an exemplary embodiment, the social network data collected by the data provider may be data that the individual has given permission for the collection thereof (e.g., by “opting-in” to the collection of the social network data). In some instances, the data collected regarding the individual's followers may only be collected for those followers that have also opted-in for data collection. The data provider may be configured to electronically transmit data signals to the processing server that are superimposed with the social network data using a suitable communication network, such as the Internet, a local area network, a wireless area network, a radio frequency network, etc. In some instances, the data provider may electronically transmit data signals associated with each user of the social network. In other instances, the data provider may aggregate user social network data in data signals that are electronically transmitted to the processing server, such as to reduce the number of transmissions.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have and require special knowledge in offered products. In some embodiments, an entity involved in a single transaction may be considered a merchant. In some instances, as used herein, the term “merchant” may refer to an apparatus or device of a merchant entity.

Microsegment—A representation of a group of consumers that is granular enough to be valuable to advertisers, marketers, offer providers, merchants, retailers, etc., but still maintain a high level of consumer privacy without the use or obtaining of personally identifiable information. Microsegments may be given a minimum or a maximum size. A minimum size of a microsegment would be at a minimum large enough so that no entity could be personally identifiable, but small enough to provide the granularity needed in a particular circumstance. Microsegments may be defined based on geographical or demographical information, such as age, gender, income, marital status, postal code, income, spending propensity, familial status, etc., behavioral variables, or any other suitable type of data, such as discussed herein. The granularity of a microsegment may be such that behaviors or data attributed to members of a microsegment may be similarly attributable or otherwise applied to consumers having similar characteristics. In some instances, microsegments may be grouped into an audience. An audience may be any grouping of microsegments, such as microsegments having a common data value, microsegments encompassing a plurality of predefined data values, etc. In some instances, the size of a microsegment may be dependent on the application. Additional detail regarding microsegments and audiences may be found in U.S. patent application Ser. No. 13/437,987, entitled “Protecting Privacy in Audience Creation,” by Curtis Villars et al., filed on Apr. 3, 2012, which is herein incorporated by reference in its entirety.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Award Identification Based on Transactional Behavior and Interests

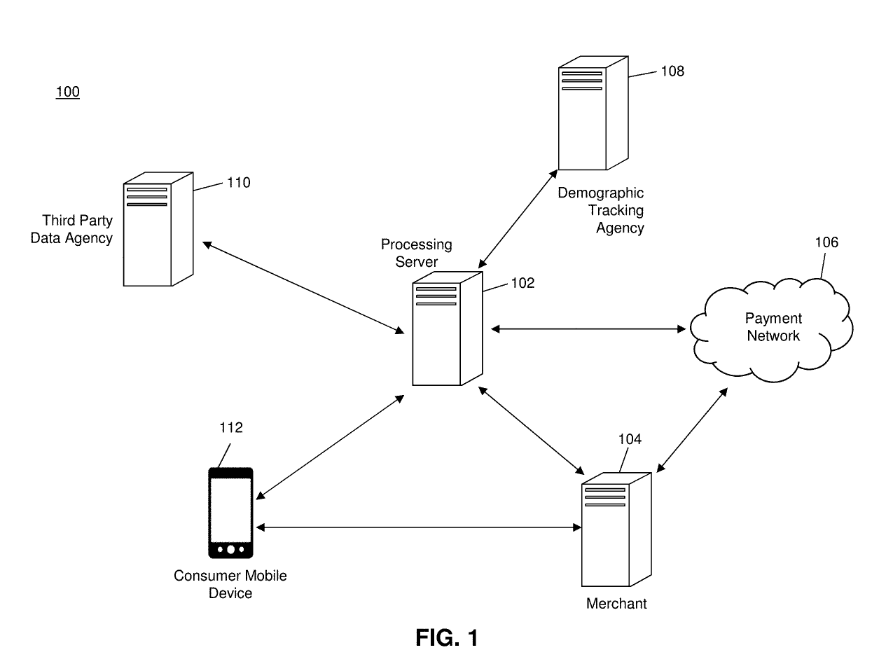

FIG. 1 illustrates a system 100 for the award identification based on transactional behavior and interests in accordance with exemplary embodiments.

Cardholders are seeking a remarkable experience, and especially expect this level of technology integration and personalization. This creates technological challenges, particularly on the scale required when tens of thousands or even millions of cardholders are involved. Cardholders may want to be rewarded for their loyalty in real-time with a surprise that is meaningful to them. Issuers are always looking to drive engagement, card transactions, and spend by bringing new innovative capabilities and concepts that no other issuers are leveraging. With targeting and messaging driven by both account activity status and cardholder interests, issuers will be able to leverage this data to drive portfolio objectives. For example, issuers may target cardholders based on account activity when they reach specific transaction thresholds (e.g., amount of spending, frequency of spending, etc.), demographics of the cardholder, interests of the cardholder (e.g., determined via account usage, as stated by the cardholder, etc.), etc. Issuers may want to use this type of data to drive portfolio objectives to provide meaningful rewards to their cardholders.

By analyzing and segmenting consumer profiles from various sources, meaningful award identification based on transactional behavior and interests may be obtained. The identification of awards is based upon transaction data of electronically processed transactions initiated by a merchant point-of-sale device and/or by an alternative device and interest data. The transaction data includes data identifying the merchant. The interest data may be obtained by, for example, a third party data agency 110, a demographic tracking agency 108, and/or may be determined by transaction data.

The system 100 may include a processing server 102, discussed in more detail below, configured to identify awards based on transaction behavior associated with a specified merchant and/or merchant computer system 104 and interest data provided by a demographic agency 108, a third party data agency 110, and/or from transaction data.

The merchant and/or merchant system 104 may have a physical location at which consumers may purchase items. As part of the purchasing process, the merchant system 104 may initiate electronically processed payment transactions using a point of sale device and the transactions may be processed by one or more payment networks 106 using traditional methods and systems. In some instances, a consumer mobile device 112 may be substituted for the merchant point-of-sale system and the transaction may be initiated from the consumer mobile device 112 while in communication with a merchant device or while the consumer mobile device 112 is located at the merchant's physical location. The consumer mobile device 112 may be any type of consumer computing device suitable for performing the functions as discussed herein, such as a desktop computer, laptop computer, notebook computer, tablet computer, cellular phone, smart phone, smart watch, smart television, wearable computing device, implantable computing device, etc. In some cases, the consumer may be contacted using any suitable delivery channel, where the computing device may be, for instance, the merchant point-of-sale system, a kiosk at a redemption location, the computing system at a box office where tickets (e.g., as the surprise) may be redeemed, etc.

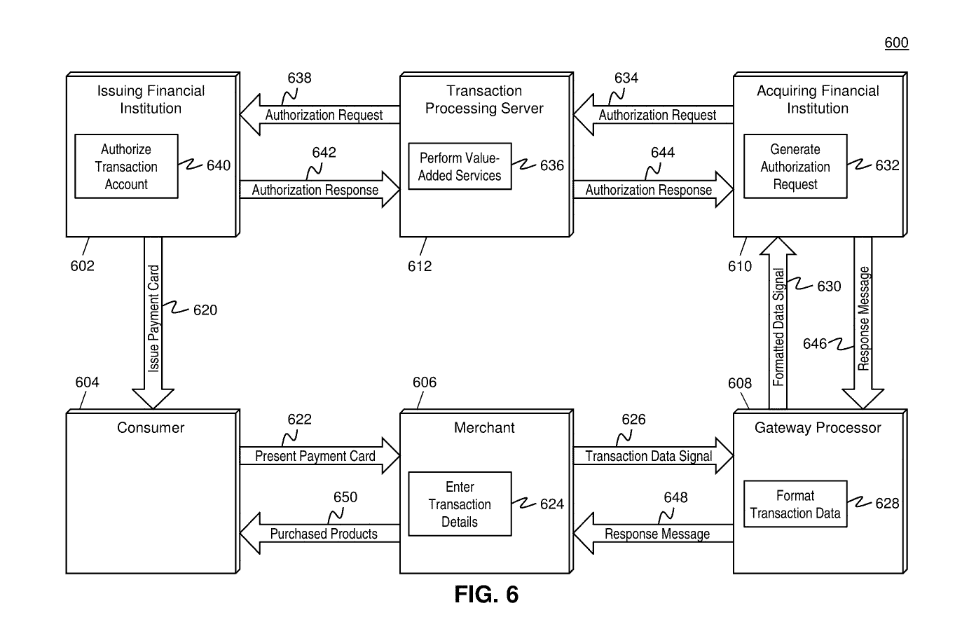

For instance, the merchant system 104 may electronically submit transaction data for a payment transaction that includes payment details received by the system from a consumer (e.g., from communicating with a consumer device via near-field-communication or other known methods, reading data from a magnetic strip of a physical card provided by a consumer, etc.) for identification of a transaction account to be used to fund the transaction as well as transaction details (such as transaction amount, product data, point of sale data, offer data, etc.) to an acquiring financial institution, such as an acquiring bank, which may generate an authorization request for the transaction. The authorization request may be a type of transaction message, which is a specialized data set formatted based on one or more standards, such as the International Organization for Standardization's ISO 8583 standard, that includes a plurality of data elements, each configured to store data as set forth by the associated standards, that may be transmitted to the payment network 106 via a specialized infrastructure configured to communicate transaction messages between specially configured computing systems, known as the “payment rails,” described in more detail below with respect to the process 600 illustrated in FIG. 6. The payment network 106 may receive the authorization request and may process the transaction accordingly using traditional methods and systems. Detailed system architecture for the processing of a payment transaction is discussed in more detail below in the system 600 illustrated in FIG. 6 and discussed below.

The processing server 102 may comprise of a transaction database which stores a plurality of transaction data. The transaction database of a processing server 102 may be configured to store a plurality of transaction data entries. Each transaction data entry may include data related to a payment transaction including at least a merchant identifier associated with a merchant 104 involved in the related payment transaction, a primary account number associated with a transaction account used in the related payment transaction, and transaction data. In some implementations, the transaction data includes at least one of: a transaction time, a transaction date, and a day of week.

The processing server 102 may be configured to receive transaction data for a plurality of payment transactions involving the merchant and/or merchant system 104 from the payment network 106. In some embodiments, the processing server 102 may be a specially configured computing device configured to communicate using the payment rails, and may receive the transaction data via the transmission of transaction messages from the payment network 106. In other embodiments, the processing server 102 may be a part of the payment network 106 and may, in some cases, be configured to process payment transactions. In such embodiments, transaction data may be captured during or subsequent to the processing of payment transactions in the payment network 106.

Transaction data acquired by the processing server 102 may include at least a primary account number, or number associated therewith, for each payment transaction. In some instances, the primary account number may be replaced in the transaction data by an encrypted number. In such instances, the primary account number may be encrypted using a suitable method of one-way encryption such that the processing server 102 may be unable to identify the primary account number to which the encrypted number corresponds. In such a case, the processing server 102 may not be able to personally identify a consumer or transaction account associated with any given payment transaction. Transaction data acquired by the processing server 102 may include transaction data for payment transactions conducted at the physical location of the merchant system 104, as well as additional transactions. For instance, the transaction data may also include transactions conducted remotely with the merchant system 104, such as online transactions, mail order transactions, telephone transactions, etc., or transactions conducted at a different location of the merchant, such as in instances where the merchant may have multiple storefronts.

The processing server 102 may comprise an account database configured to store a plurality profile data entries. Each profile data entry may include data related to a specific identified area of special interest associated with the consumer utilizing the primary account number associated with the transaction account used in the related payment transaction. In some implementations, the plurality of profile data entries is obtained from a third party server, third party data agency 110, and/or a demographic tracking agency 108.

The processing device of the processing server 102 may be configured to identify a subset of transaction data entries stored in the transaction database. Each transaction data entry in the subset may include the transaction account. The processing device of the processing server 102 may be configured to determine when the subset of transaction data entries exceeds a predetermined threshold. The processing device of the processing server 102 may qualify the transaction account for an entry into a random drawing. The random drawing may comprise a plurality of transaction accounts which have exceeded the predetermined threshold. The processing device of the processing server 102 may identify a winning transaction account from the plurality of transaction accounts that were entered into the random drawing. In some implementations, the winning transaction account is chosen randomly. The processing device of the processing server 102 may identify at least one set of interest characteristics for the winning transaction account by querying a demographic database and a profile database to identify, from an award database, a surprise based on the life stage and specific identified area of special interest of the consumer.

### Life Stages

The processing server 102 may comprise a demographic database configured to store a plurality of demographic data entries. Each demographic data entry may include data related to a life stage associated with a consumer utilizing the primary account number associated with the transaction account used in the related payment transaction. Life stages may be, for example, one or more of: pre-nesters, nesters and/or empty-nesters. In some implementations, a pre-nester may be a young couple and/or individual who does not have children, a nester may refer to a couple and/or individual who has children, and an empty-nester may refer to a couple and/or individual who has grown children that no longer live with them. Additional and/or alternative demarcations of life stages may also be used, such as based on education (e.g., high school student, undergraduate student, graduate student, post-graduate, etc.), occupation (e.g., entry-level employee, management employee, executive employee, retiree, etc.), etc. In some instances, a combination of life stages may be used for categorization and segmentation of cardholders for use in performing the functions discussed herein.

The processing server 102 may be configured to identify demographic data and/or characteristics of the consumers which transact with merchant 104 using the transaction data. In some instances, the demographic characteristic data may be obtained by the processing server 102 prior to the consumers transacting with merchants 104. The processing server 102 may receive demographic characteristic data, such as may be provided by a demographic tracking agency 108 via a device thereof. The term “demographic tracking agency” as used herein may refer to one of or both of the demographic tracking agency and a system/device thereof. The demographic tracking agency 108 may communicate, via a demographic tracking agency 108 device (e.g., a computing system, etc.), demographic characteristic data to the processing server 102 via electronic transmission of data signals superimposed with the data, which may be transmitted via suitable communication networks. Communication networks may include, for example, the Internet, cellular communication networks, radio frequency, local area networks, etc. The demographic characteristic data may include primary account numbers or numbers associated thereof and one or more demographic characteristics associated with the numbers. In some instances, each number may be individually associated with one or more demographic characteristics. In other instances, numbers may be grouped together, such as in a microsegment, where each number in the group is associated with the same set of one or more demographic characteristics. Demographic characteristics may include gender, age, income, education, occupation, residential status, familial status, relationship status, marital status, zip code, postal code, ethnicity, and any other demographic characteristic that will be apparent to persons having skill in the relevant art. The demographic tracking agency 108 may collect demographic characteristic data for consumers using traditional methods and systems, such as census data, surveys, etc. and may electronically store the data and distribute the data according to traditional methods and systems.

In some embodiments, the demographic tracking agency 108 may provide demographic characteristic data to the processing server 102, which may store the demographic characteristic data in a local database. The local database may be included in the processing server 102 or may be external to the processing server 102 and accessed remotely via a communication network. For instance, the demographic characteristics may be stored in an external database and accessed via cloud computing techniques. In other embodiments, the processing server 102 may electronically transmit a data signal comprising a data request to the demographic tracking agency 108 to request demographic characteristics for specific consumers or groups of consumers, such as consumers of the merchant 104 as identified using transaction data for the merchant 104. The demographic tracking agency 108 may identify demographic characteristics for the specific consumers or groups of consumers, and may electronically transmit a data signal superimposed with the data back to the processing server 102, which may receive and parse the demographic characteristic data to identify particular characteristic data to be used within the systems and methods disclosed herein. The processing server 102 may store the demographic characteristic data, or identified subsets of characteristic data, within an electronic data store, which may be part of the processing server 102 or external thereto. In some cases, the processing server 102 may identify demographic characteristics of a consumer prior to the receipt of transaction data for that consumer, such as to identify characteristics of the consumer prior for classification prior to identifying the consumer's purchase behaviors.

In some embodiments, demographic characteristics may be matched to transaction data by the processing server 102 or a system/device of the demographic tracking agency 108 based on primary account numbers (e.g., which may be encrypted via one-way encryption). In such embodiments, the demographic tracking agency 108 may provide (e.g., by way of a system or device thereof, etc.) demographic characteristic data that includes account numbers or groups of account numbers, and, for each account number or group, one or more demographic characteristics associated therewith. The processing server 102 may identify a primary account number for each payment transaction involving the merchant 104 from the associated transaction data, such as by extracting the account number from a data element included within a transaction message for a payment transaction, wherein the data element is configured to store a primary account number associated with the respective payment transaction. In some embodiments, the account number identified from the transaction data may then be encrypted via a one-way encryption by the processing server 102 for use in a matching process. For example, the processing server 102 and demographic tracking agency 108 may each use the one-way encryption to encrypt primary account numbers, such that demographic characteristics may be associated with transaction data using the encrypted account numbers, without the demographic characteristics being associated with an unencrypted account number. Additional detail regarding matching two data sets via encrypted identifiers may be found in U.S. patent application Ser. No. 13/554,402, entitled “System and Method for Protecting Consumer Privacy in the Measuring of the Effectiveness of Advertisements,” filed on Jul. 20, 2012, by Curtis Villars et al., which is herein incorporated by reference in its entirety.

The demographic characteristics may then be matched to the consumers of the merchant 104 using the account numbers. In embodiments where matching is performed by the processing server 102, the processing server 102 may include a specially configured module or engine that is configured to match the account numbers provided by the demographic tracking agency 108 to the account numbers extracted from the transaction data provided by the payment network 106 for transactions involving the merchant 104. The specially configured module or engine may be software or hardware that is configured to execute a query on a demographic characteristic database, wherein the demographic characteristic database comprises data entries containing the received and parsed demographic characteristic data. The data entries may be segmented based upon, for example, account number, or other identifying characteristics of a single consumer or group of consumers. The specially configured module or engine may be further configured to execute a query on transaction data stored in a transaction database, in a similar manner as the query of the demographic characteristic database. The transaction database and demographic database may or may not be similarly organized and contain similar fields of information. The module or engine may query each database based upon a particular value (e.g., account number, etc.) a group of values (e.g., certain behavioral data, etc.) or may execute a process which compares, for example, the demographic characteristic and transaction databases to identify data entries containing similar values (e.g., match multiple account numbers and/or other values present in each database, etc.). In some embodiments, other algorithms for executing a matching or comparison process known to those skilled in the art may be implemented to perform the matching process. In some embodiments, the module may output demographic characteristics retrieved from the demographic characteristic database that are associated with some or all of the matches determined by the module.

In some embodiments the account numbers provided by the demographic tracking agency 108 and/or those extracted from the transaction data may be encrypted. The demographic characteristics associated with each account number that is matched from the demographic characteristic data may then be associated with the merchant 104. In embodiments where matching is performed by the demographic tracking agency 108, the processing server 102 may electronically transmit a data signal superimposed with the account numbers identified from the transaction data involving the merchant 104 to the demographic tracking agency 108, which may perform the matching and then return the demographic characteristics of the consumers of the merchant 104 via an electronic transmission to the processing server 102.

In some embodiments, demographic characteristics may be matched to consumers using purchase behaviors. In such embodiments, the processing server 102 may be configured to identify, using a specially configured module or engine, purchase behaviors for the payment transactions involving the merchant 104. This specifically configured module or engine may be hardware or software, configured to execute a matching or comparison process, such as that described in more detail, above. Purchase behaviors may be identified based on transaction data for one or more of the payment transactions, which may include, for example, transaction amount, product data, consumer data, offer data, reward data, transaction time and/or date, etc. The purchase behaviors identified by the processing server 102 may include, for instance, average ticket size, transaction frequency, product purchasing data, return consumer frequency, first-time consumer frequency, number of transactions, etc. The purchase behaviors may then be matched to demographic characteristics by the processing server 102 or demographic tracking agency 108, used in place of account numbers. For example, the demographic tracking agency 108 may provide demographic characteristics correlated with a purchase behavior, and the processing server 102 may identify purchase behaviors for the merchant system 104 using transaction data, and thereby associate demographic characteristics to the merchant system 104 based on the correlation between demographic characteristics and purchase behavior.

Using the demographic characteristics of the consumers of the merchant 104, the processing server 102 may be configured to identify consumer interest. In some embodiments, the processing server 102 may electronically transmit a data signal superimposed with the demographic characteristics to a device or system of a third party data agency 110. As used herein, the term “third party data agency” may refer to one or both of the entity itself or a device/system thereof, depending on context. The third party data agency 110 may identify additional characteristics and/or interests of the consumer associated with the demographic characteristics provided by the processing server 102 (e.g., and associated with consumers of the merchant 104) and may electronically transmit a data signal superimposed with the third party data back to the processing server 102. In other embodiments, the third party data agency 110 may provide associations between third party data and demographic characteristics to the processing server 102, which may be stored in a database of the processing server 102, such that the processing server 102 may use the data provided by the third party data agency 110 to match interests to the identified demographic characteristics.

Consumer interests may include one or more sports, theatre, retail shopping, dining, automotive, and/or any other type of interest that may be used to identify the type of activity or purchase the consumer prefers to make. In some implementations, these interests are based on the demographic characteristics identified by the demographic tracking agency 108. Once the interest has been identified, in some embodiments, the processing server 102 may generate a data signal superimposed with the consumer interest and electronically transmit it to the consumer mobile device 104 once the consumer mobile device 104 has been identified as being associated with the winning consumer.

In some such embodiments, the processing server 102 may be part of a computing system of the merchant 104. In other embodiments, the processing server 102 may be external to the merchant 104 and may access the demographic tracking agency 108 and the third party data agency 110 remotely, such as via a communication network and using remote communication techniques, such as cloud computing techniques. In some embodiments, the processing server 102 may be configured to perform the functions of additional elements in the system 100. For instance, the processing server 102 may be configured to also perform the functions of the demographic tracking agency 108 and/or third party data agency 110.

In some implementations, the processing server 102 may identify a subset of transaction data entries stored in the transaction database. Each transaction data entry in the subset may include the transaction account. For example, a consumer may have an account which is linked to every transaction conducted by the consumer using their credit card and/or debit card.

### Transaction Thresholds

The processing server 102 may determine when the subset of transaction data entries exceeds a predetermined threshold. For example, the processing server 102, may determine when the consumer has conducted 50 transaction within a certain time period.

In some implementations, the predetermined threshold comprises one or more of: the number of transactions and/or the transaction amount. The number of transactions may be measured over a time period (e.g., 50 transaction within one month). In some implementations, the number of transaction may be cumulative (e.g., since the consumer has been a card member, the consumer has conducted 1000 transactions). The transaction amount may be measured over a time period (e.g., purchases exceed $2000 in one month). The transaction amount may be cumulative (e.g., since the consumer has been a card member, the consumer has spent $25,000).

In some implementations, the predetermined threshold may be categorized into a low number of payment transactions, a medium number of payment transactions, or a high number of payment transactions. For example, these categories may be in comparison to all other card members (e.g., determining an average) and/or a subset of card members (e.g., similarly situated card members based on demographic information, etc.).

In some implementations, the predetermined threshold may be categorized into a low amount of payment transactions, a medium amount of payment transactions, or a high amount of payment transactions. For example, these categories may be in comparison to all other card members (e.g., determining an average) and/or a subset of card members (e.g., similarly situated card members based on demographic information, etc.).

The processing server 102 may qualify the transaction account for an entry into a random drawing, the random drawing comprising a plurality of transaction accounts which have exceeded the predetermined threshold. For example, once the consumer has transacted a certain number of times or spend a certain amount of money either in total or with a particular merchant, service provider, manufacturer, etc., the consumer may be entered into a drawing to receive an award, which may be provided by the issuer or the particular merchant, service provider, manufacturer, etc.

The processing server 102 may identify a winning transaction account from the plurality of transaction accounts that were entered into the random drawing. In some implementations, the winning transaction account is chosen randomly.

The processing server 102 may identify at least one set of interest characteristics for the winning transaction account by querying the demographic database and the profile database to identify, from an award database, a surprise based on the life stage and specific identified area of special interest of the consumer.

In some instances, the processing server 102 may identify a plurality of consumer interests. For example, the processing server 102 may identify demographic characteristics of the consumers of the merchant 104 at a plurality of periods of time. For instance, the processing server 102 may identify demographic characteristics of consumers of the merchant 104 based on time of day and day of the week, such as by identifying account numbers or purchase behaviors using transaction data for payment transactions with transaction times and/or dates that correspond to the respective time of day and day of week.

In some embodiments, the processing server 102 may be configured to identify consumer interest in real-time or near real-time based on payment transactions involving the merchant 104 as they are conducted. In such an embodiment, when a payment transaction is initiated by the merchant 104, transaction data may be transmitted to the processing server 102 from the merchant 104 directly or by the payment network 106 used to process the payment transaction. The processing server 102 may use the transaction data for the payment transaction to update the demographic characteristics for the merchant 104 and identify an appropriate consumer interest based thereon in order to provide an appropriate surprise.

In some implementations the surprise may be one or more of: event tickets, restaurant gift card, activity tickets, and an item. The surprise may be based on the identified interests of the consumer in order to provide a personal effect. For example, if a consumer is a big Yankees fan, the surprise may be tickets to a Yankees game. Thus, providing a useful and personal award to the consumer.

In some implementations, the surprise comprises different categories based on the predetermined threshold. For example, the different categories comprise one or more of: once in a lifetime surprises, contextual surprises, and all surprises.

Once in a lifetime surprises may be, for example, large media event surprises to drive brand excitement and media attention. For example, backstage passes to a favorite artist, and/or super bowl tickets for a consumer's favorite team may be once in a lifetime surprises. Contextual surprises may be event or location driven surprises that are relevant and meaningful. For example, tickets to the opera may be considered contextual surprises. All surprises may be anytime anywhere card activity driven surprises. For example, a consumer may receive a free coffee at their favorite coffee shop depending on their location.

The processing server 102 may comprise a transmitting device configured to transmit notice of the identified surprise to the consumer mobile device 106. In some embodiments, the processing server 102 may instruct a third party to notify the consumer of the surprise, such as the third party data agency 110, an issuing financial institution associated with the consumer, the merchant 104, etc.

### Processing Server

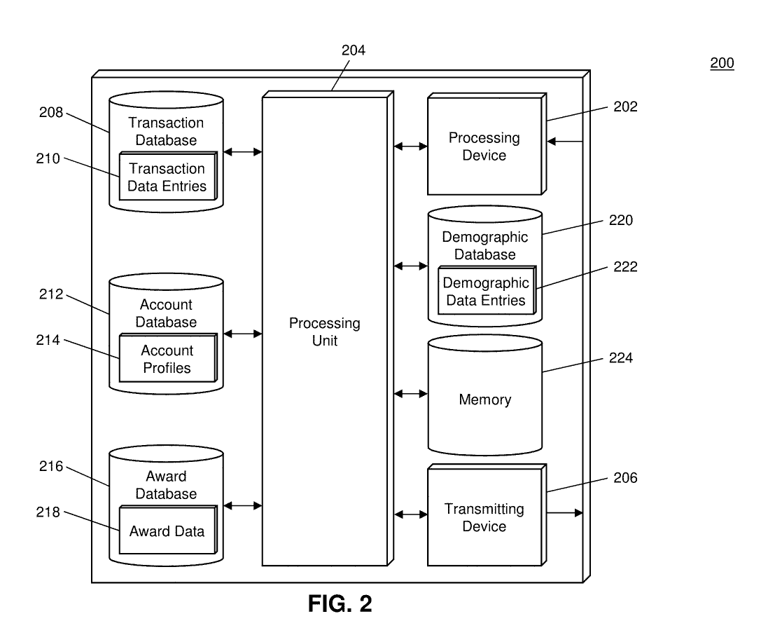

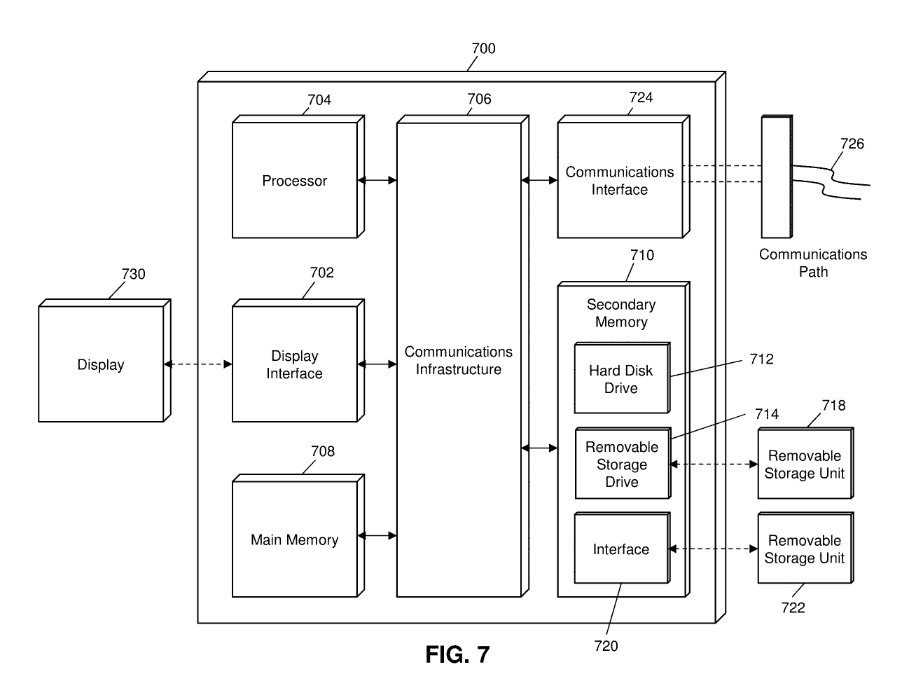

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a processing device 202. The processing device 202 may be configured to receive data over one or more networks via one or more network protocols. In some embodiments, the processing device 202 may be configured to receive data over the payment rails, such as using specially configured infrastructure associated with payment networks 106 for the transmission of transaction messages that include sensitive financial data and information. In some instances, the processing device 202 may also be configured to receive data from merchants 104, demographic tracking agencies 108, third party data agencies 110, and other entities, via devices of such entities, via alternative networks, such as the Internet. In some embodiments, the processing device 202 may be comprised of multiple units, such as different receiving units for receiving data over different networks, such as a first receiving unit for receiving data over payment rails and a second receiving unit for receiving data over the Internet. The processing device 202 may receive electronically data signals that are transmitted, where data may be superimposed on the data signal and decoded, parsed, read, or otherwise obtained via receipt of the data signal by the processing device 202. In some instances, the processing device 202 may include a parsing module for parsing the received data signal to obtain the data superimposed thereon. The parsing module may be software or hardware configured to receive a data signal, parse the data received in the signal and output the data in a usable form for the performance of the methods and systems disclosed herein.

The processing device 202 may be configured to receive transaction data from the payment network 106 using the payment rails or other suitable communication network. In some instances, the transaction data may be included in specially formatted transaction messages, which may comprise a plurality of data elements configured to store data as set forth in the associated standards. The processing device 202 may also be configured to receive demographic characteristic data from demographic tracking agencies 108 and consumer interest data from third party data agencies 110.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. For example, the processing unit 204 may include a querying module configured to query databases included in the processing server 102 to identify information stored therein. The querying module may receive an input of a particular value and/or algorithm to employ to execute a query, execute the query based upon the input data and/or algorithm (or a pre-programmed algorithm of the querying module) and output data responsive to the input value and/or algorithm. In some instances, the processing unit 204 may include a parsing module or engine configured to parse data from data signals electronically received by the processing device 202, an encryption module or engine configured to decrypt received data or data signals or to encrypt data or data signals received or transmitted by the processing server 102, using encryption methods as will be apparent to those skilled in the art, and any other modules suitable for performing the functions discussed herein. As used herein, the term “module” may describe particularly programmed hardware or software, wherein the module is configured to perform the functions by which it is defined.

The processing server 102 may also include a transaction database 208. The transaction database 208 may be configured to store a plurality of transaction data entries 210 using a suitable data storage format and schema. Each transaction data entry 210 may include data related to a payment transaction. In some embodiments, each transaction data entry 210 may comprise a specially formatted transaction message. Each transaction data entry 210 may include at least a primary account number associated with a transaction account used to fund the related payment transaction, a merchant identifier, and transaction data. The primary account number may, in some instances, be an encrypted account number. The merchant identifier may be a unique value associated with a merchant suitable for the identification thereof, such as a merchant identification number, registration number, point of sale identifier, transaction account number, etc. The transaction data may include a transaction amount, transaction time and/or date, consumer data, merchant data, offer data, reward data, loyalty data, point of sale data, geographic location data, and any other data that may be suitable for use in performing the functions disclosed herein.

In some embodiment, the processing server 102 may also include an account database 212. The account database 212 may be configured to store a plurality of account profiles 214 using a suitable data storage format and schema. Each account profile 214 may include data related to a transaction account including at least an account number associated with the related transaction account and one or more demographic characteristics associated with the related transaction account. In such embodiments, the account profiles 214 may be generated by an appropriate module or engine of the processing unit 204 based on transaction data entries 210 stored in the transaction database 208 and demographic characteristics received from the demographic tracking agency 108 by the processing device 202. For example, a querying module of the processing unit 204 may query the transaction database 208 to identify account numbers included in the transaction data entries 210 stored therein, and a matching module may be configured to match the account numbers with account numbers included in demographic characteristic data received and parsed by the processing device 202 by receiving input of the two sets of data (e.g., account numbers from the transaction database 208 and account numbers and demographic characteristics) and outputting the matched demographic characteristics and transaction data entry 210 account numbers. The processing unit 204 may then store the associated one or more demographic characteristics in an account profile 214 with the respective account number, to be stored in the account database 212. In some embodiments, each account profile 214 may include data related to a microsegment of transaction accounts. For instance, an account profile 214 may include account numbers for a plurality of transaction accounts comprising a microsegment, where each account number included in the microsegment is associated with the same one or more demographic characteristics.

In some embodiments, the processing server 102 may include an award database 216. The award database 216 may be configured to store a plurality of award data entries 218 using a suitable data storage format and schema. The award data entries 218 may include data related to identifying awards based on consumer interests including at least one demographic characteristic associated with the related purchase behavior. In some instances, an award data entry 218 may include data related to a life stage for the identification of awards based thereon.

The associated demographic characteristics for purchase behaviors may be identified by the processing unit 204 from data from the demographic tracking agency 108 received and parsed by the processing device 202. In some instances, the processing unit 204 may include a module or engine configured to associate demographic characteristics and purchase behaviors based on purchase behaviors for transaction accounts and their associated demographic characteristics and life stages. For instance, an analytic module or engine of the processing unit 204 may identify purchase behaviors for a transaction account based on transaction data in transaction data entries 210 related to payment transactions involving the transaction account (e.g., including the associated account number) by inputting the transaction data entries 210 and outputting purchase behaviors, and may associate the demographic characteristics of the transaction account (e.g., as stored in a corresponding account profile 214) with the identified purchase behaviors. In some instances, the processing unit 204 may associate demographic characteristics with purchase behaviors based on an aggregation of purchase behavior and demographic characteristic associations over a plurality of different transaction accounts.

The processing unit 204 may be configured to identify demographic characteristics of consumers of a merchant 104. The processing unit 204 may include a querying module configured to execute a query on the transaction database 208 to identify transaction data entries 210 where the included merchant identifier corresponds to a merchant identifier associated with a particular merchant 104. In embodiments where demographic characteristics are associated with account numbers, the querying module may execute a query on the account database 212 to identify account profiles 214 where the included account number corresponds to an account number included in one of the identified transaction data entries 210. The demographic characteristics of the identified account profiles 214 may then be analyzed by an analytic engine or module of the processing unit 204 and associated with the merchant 104. Analysis may be used, for instance, to identify outliers in the demographic characteristics, identify average demographic characteristics, etc. The processing unit 204 may also be configured to identify life stages for consumers of a merchant 104, such as based on the demographic characteristics, analyzed from their transaction behaviors, based on self-reporting of the consumers, etc.

In some embodiments, the processing server 102 may further include a demographic database 220. The demographic database 220 may be configured to store a plurality of demographic data entries 222 using a suitable data storage format and schema. Each demographic data entry 222 may include data related to consumer interests including one or more associated demographic characteristics. In some instances, a demographic data entry 222 may include data related to one or more life stages associated therewith.

The processing unit 204 may be configured to identify consumer interests using the demographic characteristics associated with the clientele of the merchant 104. The querying module of the processing unit 204 may execute a query on the demographic database 220 to identify a demographic data entry 222 where the included demographic characteristics correspond to the demographic characteristics identified for the consumer.

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 106 for the transmission of transaction messages that include sensitive financial data and information, such as identified payment credentials. In some instances, the transmitting unit 206 may be configured to transmit data to merchants 104, payment networks 106, demographic tracking agencies 108, third party data agencies 110, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The processing server 102 may also include a memory 224. The memory 224 may be configured to store data for use by the processing server 102 in performing the functions discussed herein. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for application programs, rules and algorithms for generating purchase behaviors, and other data that may be suitable for use by the processing server 102 in the performance of the functions disclosed herein as will be apparent to persons having skill in the relevant art.

In embodiments where visual content selections may be identified by the processing server 102, the components of the processing server 102 illustrated in FIG. 2 and discussed herein may be configured to perform the functions discussed above.

### Process for Award Identification Based on Transactional Behavior

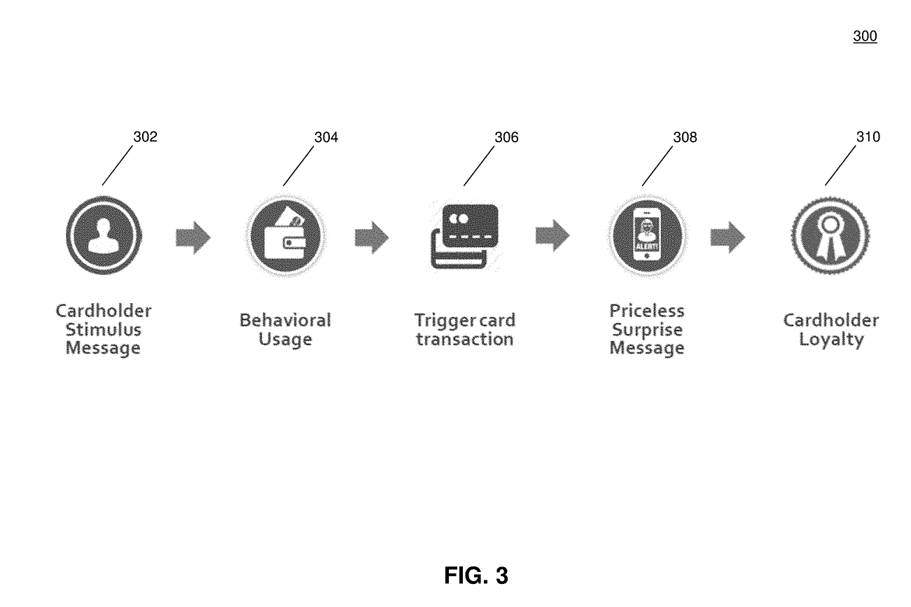

FIG. 3 is a flow diagram illustrating a process for award identification based on transactional behavior and interests using the system of FIG. 1 in accordance with exemplary embodiments.

In step 302, the processing server 102 may determine a cardholder stimulus message. For example, a father who is a baseball fan may be surprised with a pair of baseball tickets. In step 304, the processing server 102 monitors and tracks the consumer's behavior usage. For example, the processing server 102 may leverage three different types of segmentation and/or data points, such as leveraging cardholders' behavior (e.g., if they are low usage, mid usage, high usage cardholders). Next, the processing server 102 may determine life stages and life cycles of a consumer. For example, different segments of life stages may comprise pre-nesters, nesters, empty-nesters, working couples, working singles, non-working moms or dads, etc. Life stages may be determined based on consumer behavior, self-reporting, etc.

Another data point that may be considered by the processing server 102 are consumer special interests, which may also be referred to herein as consumer “passion points.” A special interest or passion point may be an interest of the consumer that may be used in the identification of rewards or surprises that may be provided to a cardholder. Passion points may include music, entertainment, sports, travel, arts, culinary, shopping, philanthropy, environment, etc. In some instances, a passion point may have one or more sub-interests. For instance, the passion point of sports may have sub-interests regarding the types of sports that the consumer is interested in. For example, a cardholder may be interested in sports, and more specifically interested in only baseball and football. In some embodiments, the processing server 102 may have a ranking or other priority for a consumer's passion points, such as may be determined based on their transaction behavior, past behavior regarding surprises, self-reporting, etc.

In addition, the processing server 102 may access the demographic tracking agency 108 and/or the third party data agency 110 to understand additional information about the consumer. The demographic tracking agency 108, for example, may store consumer demographics. The consumer demographics may include one or more demographic characteristics associated with each of a plurality of account numbers, groups of account numbers (e.g., microsegments), or purchase behaviors. Demographic characteristics may include, for example, age, gender, income, education, occupation, residential status, familial status, relationship status, marital status, ethnicity, zip code, postal code, etc. In some instances, demographic characteristics may be represented by an exact value (e.g., an age of 30 years) or a range of values (e.g., an age between 25 and 30).

By accessing the demographic tracking agency 108 and/or the third party data agency 110, the processing server 102 may determine what are the similarities between different consumers. For example, if an issuer is looking at established dads, the processing server 102 may determine what established dads really care about. Do they care about their family? Do they really want to have time for themselves? What is it that really drives them in their lives at that point in time? The processing server 102 may use transaction behavior of the consumers and other related consumers to identify such data, where the other related consumers may be consumers having the same or similar demographic characteristics, life stages, etc.

In step 306, the processing server 102 triggers a card transaction. For example, the processing device of the processing server 102 may be configured to determine when the subset of transaction data entries exceeds a predetermined threshold (e.g., did a certain cardholder exceed 30 transaction in a month). The processing device of the processing server 102 may qualify the transaction account for an entry into a random drawing. The random drawing may comprise a plurality of transaction accounts which have exceeded the predetermined threshold. The processing device of the processing server 102 may identify a winning transaction account from the plurality of transaction accounts that were entered into the random drawing (e.g., randomly draw winning cardholder). In some implementations, the winning transaction account is chosen randomly. For example, the processing server 102 may determine that the cardholder is eligible to be surprised at the next transaction random process.

In step 308, the processing server 102 provides a priceless surprise message. The processing device of the processing server 102 may identify at least one set of interest characteristics for the winning transaction account by querying a demographic database and a profile database to identify, from an award database, a surprise based on the life stage and specific identified area of special interest of the consumer. For example, the processing server 102 may invite the cardholder that has an interest in baseball and a guest to a Yankees game. In step 310, the processing server 102 will determine if cardholder loyalty is obtained. For example, the processing server 102 may determine if the cardholder increases their card usage following receipt of the surprise.

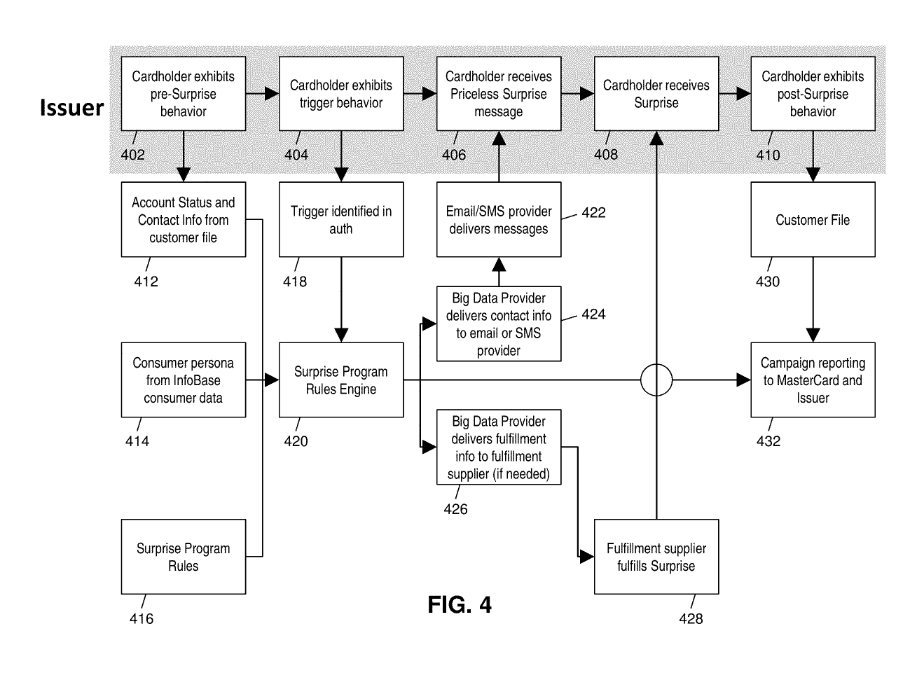

FIG. 4 is a flow diagram illustrating a method for award identification based on transactional behavior and interests using the processing server 102 of FIG. 2 in accordance with exemplary embodiments.

In step 402, the processing sever 102 may monitor cardholder pre-surprise behavior. For example, in step 412, the processing server 102 may monitor the cardholder's account status and contact information from the customer file, such as by querying for the cardholder's information at periodic intervals. In step 414, the processing server 102 may monitor surprise program rules 416, such as by regularly querying for program rules to identify changes, modifications, additions, revisions, etc. to the program rules.

In step 404, the processing server 102 may determine that the cardholder exhibits trigger behavior. In step 418, the processing server may identify a trigger in authentication. For example, the trigger may be that the payment transaction related to the authentication includes transaction data that pushes the consumer's transaction behavior beyond a threshold that, based on program rules, triggers a surprise. For instance, the transaction may result in the cardholder reaching a spending threshold with a particular merchant. In step 420, the processing server 102 may access the surprise program rules engine.

In step 406, the processing server 102 may provide the cardholder with a priceless surprise message. In step 422, the message may be delivered by email and/or SMS. In step 424, the message may be provided by third party data agency 110. In step 426, the third party data agency may deliver fulfillment information to a fulfillment supplier to fulfill the surprise.

In step 408, the processing server 102 may monitor the cardholder receiving the surprise. For example, the processing server 102 may periodically query for the cardholder's transaction behavior following the surprise to identify if the surprise is used or the cardholder's behavior following receipt of the surprise. In step 428, a fulfillment supplier may fulfill the surprise.

In step 410, the processing server 102 may monitor the cardholder's post-surprise behavior (e.g., to determine if the cardholder become a more loyal customer to the merchant related to the surprise), such as by periodically reviewing the cardholder's transaction behavior following receipt and/or fulfillment of the surprise. In step 430, the processing server 102 may update the consumer file which may be stored in the account database 212. In step 432, the processing server 102 may use the information in the consumer file to create a report.

### Exemplary Method for Award Identification Based on Transaction Behavior and Interests

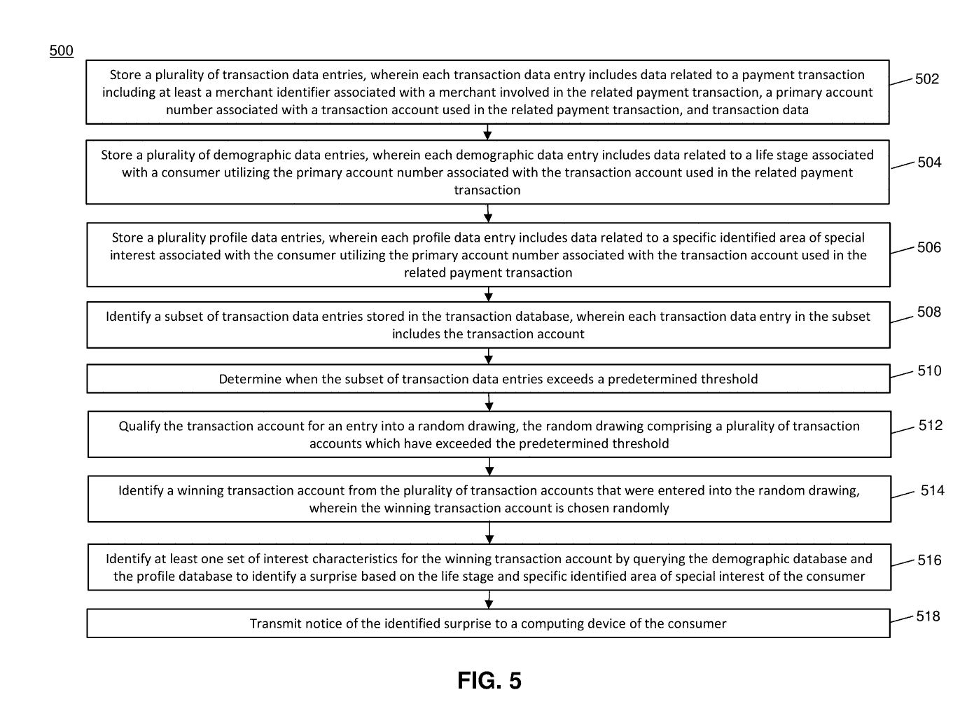

FIG. 5 is a flow chart illustrating an exemplary method 500 for award identification based on transactional behavior and interests in accordance with exemplary embodiments.

In step 502, a plurality of transaction data entries (e.g., transaction data entries 210) may be stored in a transaction database (e.g., the transaction database 208) of a processing server (e.g., the processing server 102), wherein each transaction data entry includes data related to a payment transaction including at least a merchant identifier associated with a merchant involved in the related payment transaction, a primary account number associated with a transaction account used in the related payment transaction, and transaction data. In some implementations, the transaction data includes at least one of: a transaction time, a transaction date, and a day of week.

In step 504, a plurality of demographic data entries (e.g., demographic data entries 222) may be stored in a demographic database (e.g., the demographic database 220) of a processing server (e.g., the processing server 102), wherein each demographic data entry includes data related to a life stage associated with a consumer utilizing the primary account number associated with the transaction account used in the related payment transaction. In some implementations, the life stage comprises one of: a pre-nester, a nester, and an empty nester.

In step 506, a plurality of profile data entries (e.g., account profiles 214) may be stored in an account database (e.g., the account database 212) of a processing server (e.g., the processing server 102), wherein each profile data entry includes data related to a specific identified area of special interest associated with the consumer utilizing the primary account number associated with the transaction account used in the related payment transaction. In some implementations, the plurality of profile data entries is obtained from a third party server.

In step 508, a processing device (e.g., the processing device 202) may identify a subset of transaction data entries stored in the transaction database, wherein each transaction data entry in the subset includes the transaction account.

In step 510, a processing device (e.g., the processing device 202) may determine when the subset of transaction data entries exceeds a predetermined threshold. In some implementations, the predetermined threshold comprises one or more of: the number of transaction, the transaction amount. In some implementations, the predetermined threshold is categorized into a low number of payment transactions, a medium number of payment transactions, or a high number of payment transactions. In some implementations, the predetermined threshold is categorized into a low amount of payment transactions, a medium amount of payment transactions, or a high amount of payment transactions.

In step 512, a processing device (e.g., the processing device 202) may qualify the transaction account for an entry into a random drawing, the random drawing comprising a plurality of transaction accounts which have exceeded the predetermined threshold. In step 514, a processing device (e.g., the processing device 202) may identify a winning transaction account from the plurality of transaction accounts that were entered into the random drawing, wherein the winning transaction account is chosen randomly.

In step 516, a processing device (e.g., the processing device 202) may identify at least one set of interest characteristics for the winning transaction account by querying the demographic database and the profile database to identify a surprise based on the life stage and specific identified area of special interest of the consumer. In some implementations, the surprise is one or more of: event tickets, restaurant gift card, activity tickets, and/or an item. In some implementations, the surprise comprises different categories based on the predetermined threshold. In some implementations, the different categories comprise one or more of: once in a lifetime surprises, contextual surprises, and all surprises.

In step 518, a transmitting device (e.g., the transmitting device 206) may transmit notice of the identified surprise to a mobile device of the consumer.

In one embodiment, the method 500 may further include storing, in an account database (e.g., the account database 212) of the processing server, a plurality of account profiles (e.g., account profiles 214), wherein each account profile 214 includes data related to a transaction account including at least a specific account number associated with the related transaction account and one or more demographic characteristics corresponding to one or more consumers associated with the related transaction account, wherein identifying the at least one set of demographic characteristics: includes identifying, by the processing device of the processing server, a subset of account profiles stored in the account database, wherein each account profile in the subset includes a specific account number corresponding to a primary account number included in at least one transaction data entry in the identified subset; and is based on the one or more demographic characteristics included in each account profile in the identified subset of account profiles.

In some embodiments, the method 500 may also include identifying, by the processing device of the processing server, a plurality of purchase behaviors based on at least the transaction data included in each transaction data entry in the identified subset of transaction data entries. In a further embodiment, the method 500 may even further include storing, in a purchase database (e.g., the award database 216) of the processing server, a plurality of purchase behaviors entries (e.g., award data entries 218), wherein each purchase behavior entry includes data related to a purchase behavior including at least one demographic characteristic associated with the related purchase behavior, and wherein identifying the at least one set of demographic characteristics: includes identifying, by the processing device of the processing server, a subset of purchase behavior entries stored in the purchase database, wherein each purchase behavior entry in the subset is related to a purchase behavior included in the identified plurality of purchase behaviors; and is based on the at least one demographic characteristic included in each purchase behavior entry in the identified subset of purchase behavior entries. In another further embodiment, the method 500 may even further include: transmitting, by the transmitting device of the processing server, a request for demographic characteristics, wherein the request includes at least the identified plurality of purchase behaviors; and receiving, by the receiving device of the processing server, the at least one set of demographic characteristics, wherein each of the at least one set of demographic characteristics is based on the identified plurality of purchase behaviors.

In some embodiments, each set of demographic characteristics of the identified at least one set of demographic characteristics may be associated with one or more temporal characteristics, and the one or more temporal characteristics may be transmitted with the identified ambient media selection corresponding to the associated set of demographic characteristics. In a further embodiment, the one or more temporal characteristics may be based on at least the transaction data included in each of the one or more transaction data entries on which the associated set of demographic characteristics are based. In one embodiment, the transaction data may include at least one of: transaction time, transaction date, and day of week.

As discussed above, in some embodiments, the method 500 may be utilized for the identification of either music or visual content selections, or both, rather than just one type of selection. In such embodiments using visual content, a visual content request may be received, and visual content data identified based on the demographic characteristics, which may be transmitted in step 512.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the merchant 104, processing server 102, and payment network 106. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3A, 3B, 4, and 5, discussed above, with respect to the step or steps involved in the processing of a payment transaction. In addition, the entities discussed herein for performing the process 600 may include one or more computing devices or systems configured to perform the functions discussed below. For instance, the merchant 604 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicate electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 640 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A, 3B, and 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for award identification based on transaction history and consumer interests. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for award identification based on transactional behavior and interests, comprising:
storing, in a transaction database of a processing server, a plurality of transaction data entries, wherein each transaction data entry includes data related to a payment transaction including at least a merchant identifier associated with a merchant involved in the related payment transaction, a primary account number associated with a transaction account used in the related payment transaction, and transaction data;
storing, in a demographic database of a processing server, a plurality of demographic data entries, wherein each demographic data entry includes data related to a life stage associated with a consumer utilizing the primary account number associated with the transaction account used in the related payment transaction;
storing, in an account database of the processing server, a plurality profile data entries, wherein each profile data entry includes data related to a specific identified area of special interest associated with the consumer utilizing the primary account number associated with the transaction account used in the related payment transaction;
identifying, by a processing device of the processing server, a subset of transaction data entries stored in the transaction database, wherein each transaction data entry in the subset includes the transaction account;
determining, by the processing device of the processing server, when the subset of transaction data entries exceeds a predetermined threshold;
qualifying, by the processing device of the processing server, the transaction account for an entry into a random drawing, the random drawing comprising a plurality of transaction accounts which have exceeded the predetermined threshold;
identifying, by the processing device of the processing server, a winning transaction account from the plurality of transaction accounts that were entered into the random drawing, wherein the winning transaction account is chosen randomly;
identifying, by the processing device of the processing server, at least one set of interest characteristics for the winning transaction account by:
querying, by a querying module of the processing server, the demographic database and the profile database to identify, from an award database, a surprise based on the life stage and specific identified area of special interest of the consumer; and
transmitting, by a transmitting device of the processing server, notice of the identified surprise to a computing device of the consumer.

2. The method of claim 1, wherein the surprise is one or more of: event tickets, restaurant gift card, activity tickets, and an item.

3. The method of claim 1, wherein the plurality of profile data entries is obtained from a third party server.

4. The method of claim 1, wherein the predetermined threshold comprises one or more of: the number of transaction, the transaction amount.

5. The method of claim 1, wherein the predetermined threshold is categorized into a low number of payment transactions, a medium number of payment transactions, or a high number of payment transactions.

6. The method of claim 1, wherein the predetermined threshold is categorized into a low amount of payment transactions, a medium amount of payment transactions, or a high amount of payment transactions.

7. The method of claim 1, wherein the surprise comprises different categories based on the predetermined threshold.

8. The method of claim 7, wherein the different categories comprise one or more of: once in a lifetime surprises, contextual surprises, and all surprises.

9. The method of claim 1, wherein the life stage comprises one of: a pre-nester, a nester, and an empty nester.

10. The method of claim 1, wherein the transaction data includes at least one of: a transaction time, a transaction date, and a day of week.

11. A system for award identification based on transactional behavior and interests, comprising:
a transaction database of a processing server configured to store a plurality of transaction data entries, wherein each transaction data entry includes data related to a payment transaction including at least a merchant identifier associated with a merchant involved in the related payment transaction, a primary account number associated with a transaction account used in the related payment transaction, and transaction data;
a demographic database of a processing server configured to store a plurality of demographic data entries, wherein each demographic data entry includes data related to a life stage associated with a consumer utilizing the primary account number associated with the transaction account used in the related payment transaction;
an account database of the processing server configured to store a plurality profile data entries, wherein each profile data entry includes data related to a specific identified area of special interest associated with the consumer utilizing the primary account number associated with the transaction account used in the related payment transaction;
a processing device of the processing server configured to:
identify a subset of transaction data entries stored in the transaction database, wherein each transaction data entry in the subset includes the transaction account;
determine when the subset of transaction data entries exceeds a predetermined threshold;
qualify the transaction account for an entry into a random drawing, the random drawing comprising a plurality of transaction accounts which have exceeded the predetermined threshold;
identify a winning transaction account from the plurality of transaction accounts that were entered into the random drawing, wherein the winning transaction account is chosen randomly; and
identify at least one set of interest characteristics for the winning transaction account by querying the demographic database and the profile database to identify, from an award database, a surprise based on the life stage and specific identified area of special interest of the consumer; and
a transmitting device configured to transmit notice of the identified surprise to a computing device of the consumer.

12. The system of claim 11, wherein the surprise is one or more of: event tickets, restaurant gift card, activity tickets, and an item.

13. The system of claim 11, wherein the plurality of profile data entries is obtained from a third party server.

14. The system of claim 11, wherein the predetermined threshold comprises one or more of: the number of transaction, the transaction amount.

15. The system of claim 11, wherein the predetermined threshold is categorized into a low number of payment transactions, a medium number of payment transactions, or a high number of payment transactions.

16. The system of claim 11, wherein the predetermined threshold is categorized into a low amount of payment transactions, a medium amount of payment transactions, or a high amount of payment transactions.

17. The system of claim 11, wherein the surprise comprises different categories based on the predetermined threshold.

18. The system of claim 17, wherein the different categories comprise one or more of: once in a lifetime surprises, contextual surprises, and all surprises.

19. The system of claim 11, wherein the life stage comprises one of: a pre-nester, a nester, and an empty nester.

20. The system of claim 11, wherein the transaction data includes at least one of: a transaction time, a transaction date, and a day of week.
